(19) United States
(12) Patent Application Publication
(10) Pub. No.: US 2010/0114938 A1
(43) Pub. Date: May 6, 2010

(54) SEARCH RESULTS FOR A TOPIC THAT INCLUDE A LIST OF MESSAGING USERS THAT HAVE PREVIOUSLY SEARCHED ON THAT TOPIC

(75) Inventor: Jeff Weng, Taipei (TW)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 12/254,774

(22) Filed: Oct. 20, 2008

(51) Int. Cl. G06F 17/30; G06F 15/16

(52) U.S. Cl. 707/769; 709/206; 707/E17.014; 707/E17.032

(57) ABSTRACT

Embodiments are directed towards integrating searching functionality with chat capability wherein the chat selections are selected and displayed based on a user's search query. In response to a searcher performing a search query, an analysis is automatically performed to identify others in a community that has recently performed searches employing same and/or similar search query terms. A list of the others identified may filtered based on, for example, demographics, time, location, and/or a variety of other user preferences. A chat (or other messaging) session may be initiated by either user to enable searchers to communicate and refine and/or improve their search queries.

### TECHNICAL FIELD

The present invention relates generally to search queries over a network and, more particularly, but not exclusively to combining chat functionality with online searching to enable a searcher to chat with another user that recently performed a similar search query.

### BACKGROUND

Tremendous changes have been occurring in the Internet that influence our everyday lives. For example, in today's society, one of the first activities that a user might perform when turning on their computers is to start up their search tools. In fact, use of Internet search tools have been so common, that it is not uncommon to see a person on a bus, train, or even a boat, to be using their mobile devices to search for merchants, restaurants, music, businesses, friends, or the like.

However, performing a search query for user relevant information still remains cumbrous. Often, the user might have to perform several search queries to obtain relevant search results. Irrelevant search results mean that the user is less likely to find when they are looking for, which in turn may translate into lost opportunities for merchants, or other businesses, to prosper from the user. Therefore, many businesses are searching for new ways to make search results more relevant to the user. Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a client device that may be included in a system implementing the invention;

FIG. 3 shows one embodiment of a network device that may be included in a system implementing the invention;

FIG. 4 illustrates a logical flow diagram generally showing one embodiment of an overview process for refining search queries to integrate a search result with chat capability; and

FIG. 5 illustrates one non-limiting, non-exhaustive embodiment of an example screen shot useable to provide chat functionality integrated with searching.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated the present invention is directed towards integrating searching functionality with chat capability wherein the chat selections are selected and displayed based on a user's search query. Thus, in one embodiment, a searcher may provide a search query to a search tool. In response, an analysis is automatically performed to identify others in a community that has recently performed searches employing same and/or similar search query terms. In one embodiment, a list of the others identified may be subject to various filtering criteria, including, but not limited to demographics, time, location, and/or a variety of other user preferences. In one embodiment, a chat session may be initiated by either user. For example, in one embodiment, at least one of the other users may have selected to be notified of searchers performing searches similar to their search query, but at some later time after their own search. In such a situation, both the earlier searcher might be notified of the current searcher, and be enabled to establish a chat session with that current searcher. In this manner, members of the community may be enabled to communicate and refine and/or improve their search queries, and therefore, potentially improve a search result. Moreover, by integrating chat with searches, social networking opportunities between persons with potentially similar interests may be increased.

In one embodiment, the communications may be performed between searchers using chat sessions. However, the invention is not limited to chats, and other communication techniques may also be used, including but not limited to short messaging services (SMS), Multimedia Messaging Service (MMS), email, Voice-over-Internet protocol (VoIP), or the like. Moreover, in one embodiment, the chat session may employ textual messaging and/or video chatting.

In one embodiment, to protect a user participate in community searching, an alias, nickname, or the like, might be displayed rather to a searcher rather than user's actual identity. In one embodiment, communications might be further protected, by enabling those receiving a solicitation to communicate, to decline such offers, while maintaining a level of privacy, and/or anonymity.

### Illustrative Operating Environment

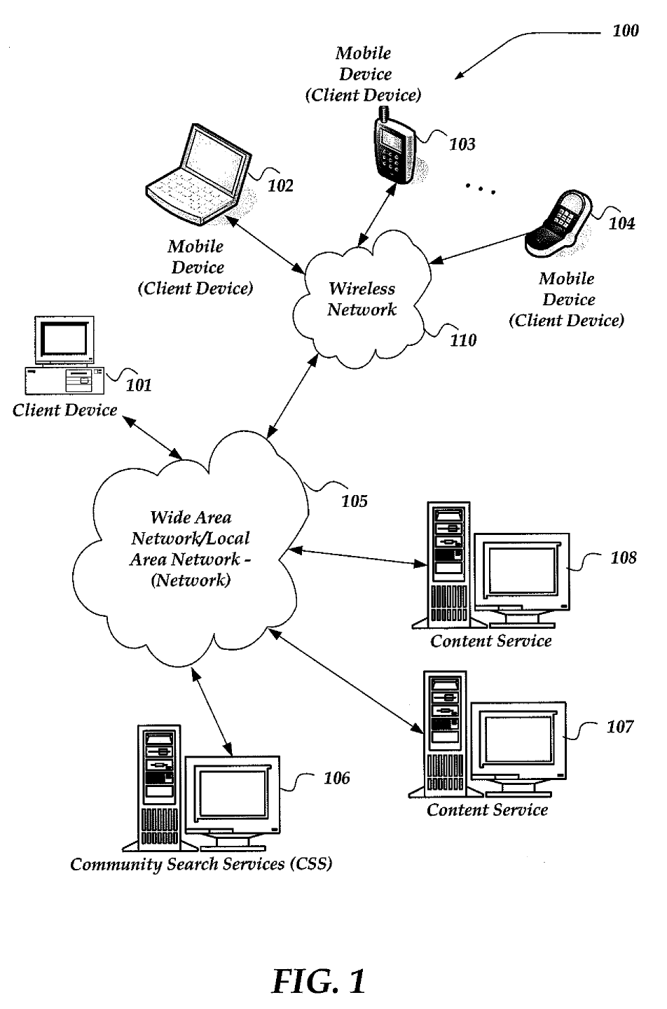

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)—(network) 105, wireless network 110, Community Search Services (USS) 106, client devices 101-104, and content services 107-108.

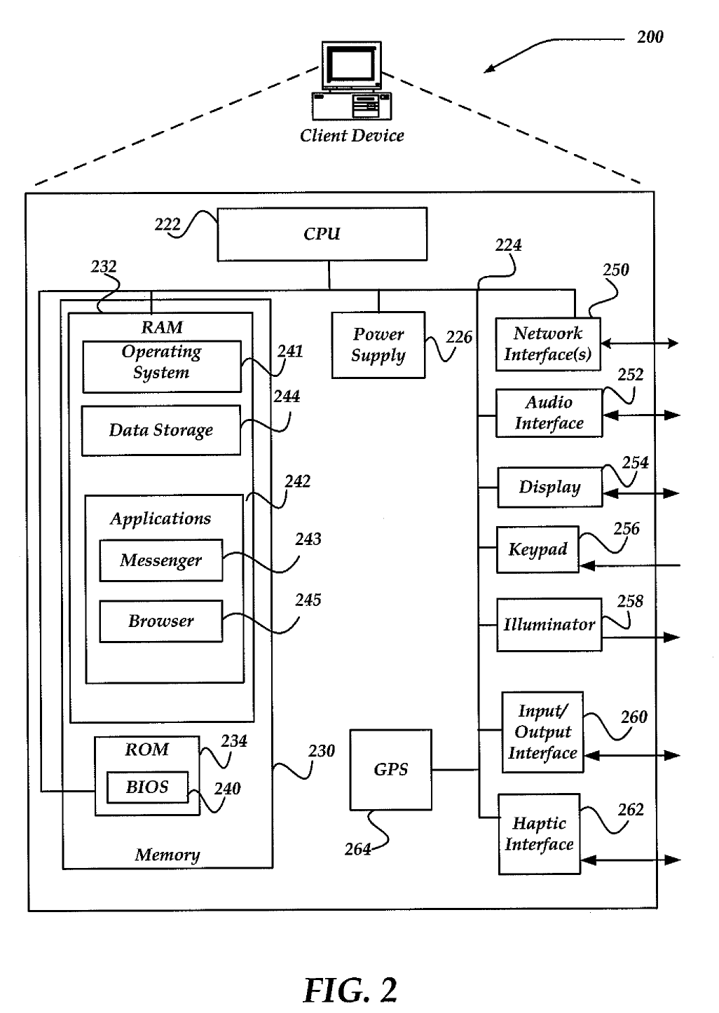

One embodiment of client devices 102-103 is described in more detail below in conjunction with FIG. 2. Generally, however, client devices 102-104 may include virtually any portable computing device capable of receiving and sending a message over a network, such as network 105, wireless network 110, or the like. Client devices 102-104 may also be described generally as client devices that are configured to be portable. Thus, client devices 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, client devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

Client device 101 may include virtually any computing device capable of communicating over a network to send and receive information, including social networking information, performing search queries, or the like. Client device 101 may also include client applications such as those described above, as well as being configured to provide location information.

The set of such devices may include devices that typically connect using a wired or wireless communications medium such as personal computers, multiprocessor systems, microprocessor-based or programmable consumer electronics, network PCs, or the like. Moreover, at least some of client devices 102-104 may operate over wired and/or wireless network.

A web-enabled client device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. In one embodiment, a user of the client device may employ the browser application to perform a search over a network. However, another application may also be used to perform a search over the network.

Client devices 101-104 also may include at least one other client application that is configured to receive content from another computing device. The client application may include a capability to provide and receive textual content, graphical content, audio content, and the like. The client application may further provide information that identifies itself, including a type, capability, name, and the like. In one embodiment, client devices 101-104 may uniquely identify themselves through any of a variety of mechanisms, including a phone number, Mobile Identification Number (MIN), an electronic serial number (ESN), or other mobile device identifier. The information may also indicate a content format that the mobile device is enabled to employ. Such information may be provided in a network packet, or the like, sent to CSS 106, content services 107-108, or other computing devices.

Client devices 101-104 may further be configured to include a client application that enables the end-user to log into an end-user account that may be managed by another computing device, such as content services 107-108, CSS 106, or the like. Such end-user account, for example, may be configured to enable the end-user to receive emails, send/receive IM messages, SMS messages, access, and/or modify selected web pages, participate in a social networking activity, perform community search queries, or the like. However, participation in various social networking activities, performing community search queries, or the like, may also be performed without logging into the end-user account. Such search queries might be performed using, for example, CSS 106, where the searches might be performed on content provided through content services 107-108. In one embodiment, client devices 101-104 may be configured to enable a user to perform search queries, wherein results of the search queries are displayed along with a list of one or more other members of a community that may have recently performed the same or similar search query. In one embodiment, the list of other members may be configured such that the user may then select to conduct a chat session, email session, or other form of communication with one or more members identified in the list. Such communications may then enable the user to refine their searches and/or enhance their social network.

Wireless network 110 is configured to couple client devices 102-104 and its components with network 105. Wireless network 110 may include any of a variety of wireless sub-networks that may further overlay stand-alone ad-hoc networks, and the like, to provide an infrastructure-oriented connection for client devices 102-104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as client devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between client devices 102-104 and another computing device, network, and the like.

Network 105 is configured to couple network devices with other computing devices, including, CSS 106, content services 107-108, client device 101, and through wireless network 110 to client devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between computing devices.

Additionally, communication media typically embodies computer-readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

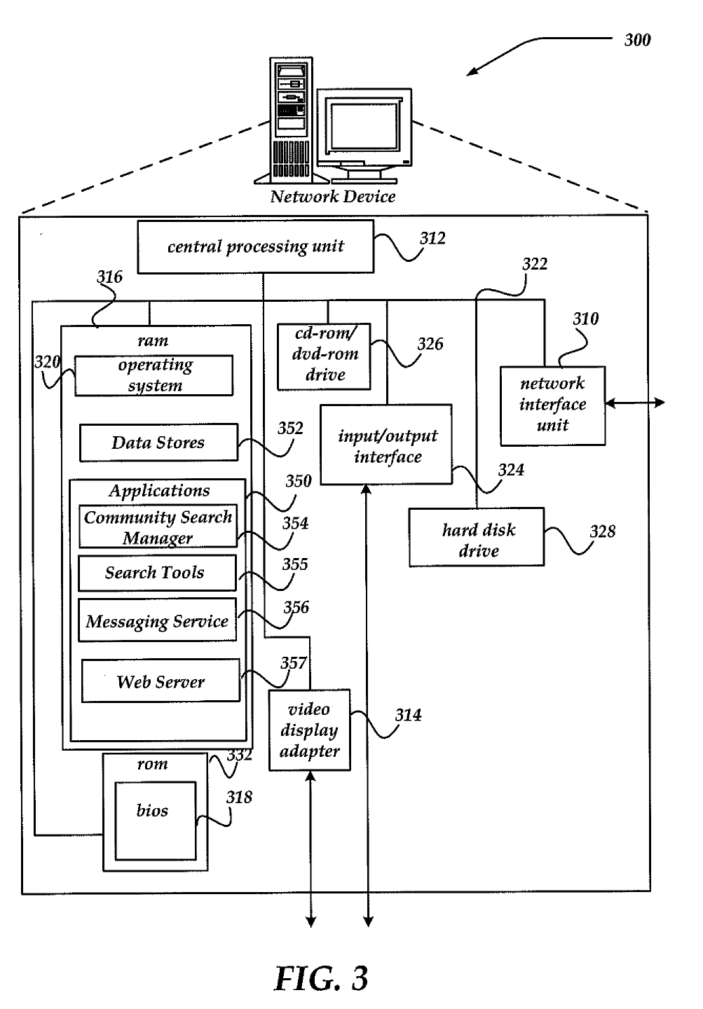

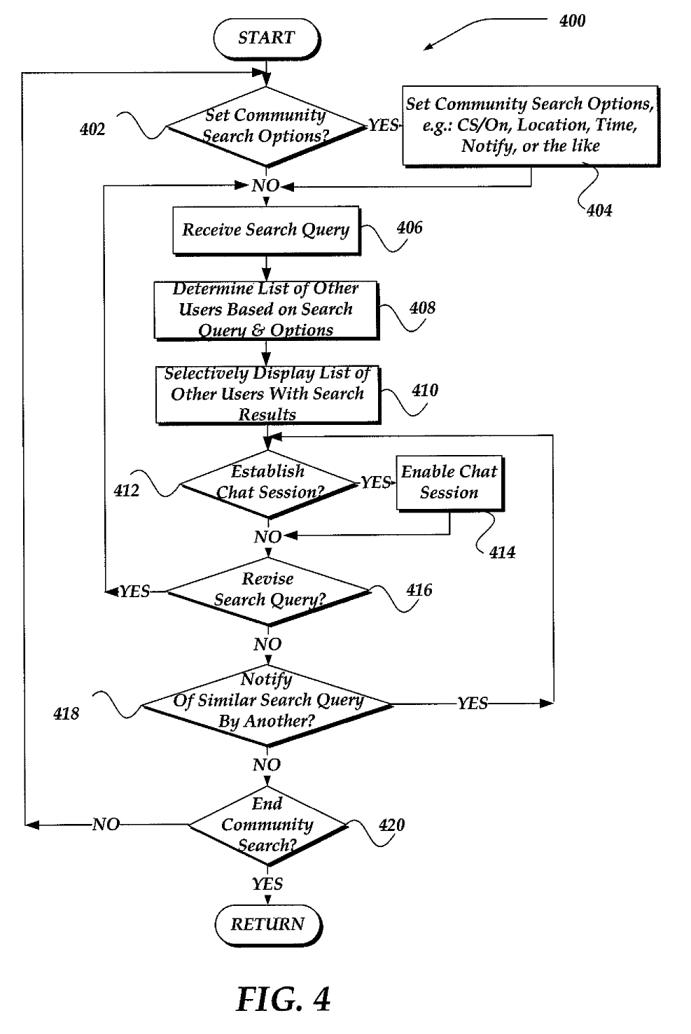

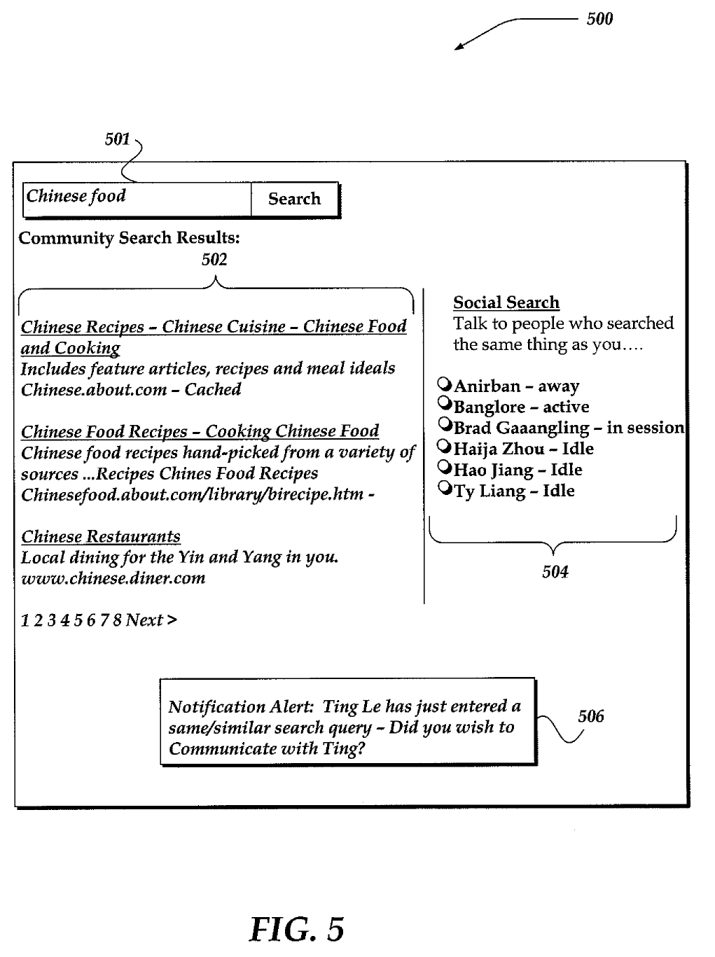

One embodiment of CSS 106 is described in more detail below in conjunction with FIG. 3. Briefly, however, CSS 106 may include any computing device capable of connecting to network 105 to receive and perform community searches. That is, a user of client devices 101-104 may select to register to employ community searches that enable the user to be selectively informed of others having performed a same or similar search, and to further communicate with at least one of the identified other searchers. Thus, CSS 106 is configured to enable a user to register, provide selected information about themselves, and to select one or more community search options. Such options include, but are not limited to turning on/off chat displays with search results; selecting to employ a variety of options in selecting a chat display, including but not limited to demographics, location, time, or the like. In one embodiment, CSS 106 enables a user to select to be notified of others that perform same and/or similar search queries after the user has performed their search query. Such notification may be provided with a search result, as a separate email message, IM message, SMS message, a notification alert within a browser window, and/or any of a variety of other mechanisms. In one embodiment, CSS 106 may employ a process such as that described below in conjunction with FIG. 4 to enable community searches (or sometimes referred to as chat search queries). Moreover, CSS 106 may employ a browser window such as described below in conjunction with FIG. 5 to provide a user interface for use by client devices 101-104 for enabling chat searches.

Devices that may operate as CSS 106 include various network devices, including, but not limited to personal computers desktop computers, multiprocessor systems, microprocessor-based or programmable consumer electronics, network PCs, servers, network appliances, and the like.

Although FIG. 1 illustrates CSS 106 as a single computing device, the invention is not so limited. For example, one or more functions of CSS 106 may be distributed across one or more distinct computing devices. For example, managing search queries may be performed by one computing device, while identifying others in a community that may have performed a same or similar search, and/or displaying of a list of identified others with a search result may be performed by another computing device, without departing from the scope or spirit of the present invention.

Content services 107-108 represents any of a variety of network devices to provide content and/or services accessible by client devices 101-104. Such services include, but are not limited to merchant sites, educational sites, personal sites, music sites, video sites, and/or the like. In fact, content services 107-108 may provide virtually any content and/or service that a user of client devices 101-104 may want to perform a search for.

Devices that may operate as content servers 107-18 include personal computers desktop computers, multiprocessor systems, microprocessor-based or programmable consumer electronics, network PCs, servers, and the like.

### Illustrative Client Device

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, one embodiment of at least one of client devices 101-104 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by client device 200 to store, among other things, applications 242 and/or other data. For example, data storage 244 may also be employed to store information that describes various capabilities of client device 200. The information may then be provided to another device based on any of a variety of events, including being sent as part of a header during a communication, sent upon request, or the like. Moreover, data storage 244 may also be employed to store social networking information including address books, buddy lists, aliases, or the like. At least a portion of the information may also be stored on a disk drive or other storage medium (not shown) within client device 200.

Applications 242 may include computer executable instructions which, when executed by client device 200, transmit, receive, and/or otherwise process messages (e.g., SMS, MMS, IM, email, and/or other messages), audio, video, and enable telecommunication with another user of another client device. Other examples of application programs include calendars, search programs, email clients, IM applications, SMS applications, VOIP applications, contact managers, task managers, transcoders, database programs, word processing programs, security applications, spreadsheet programs, games, search programs, and so forth. Applications 242 may include, for example, messenger 243, and browser 245.

Browser 245 may include virtually any application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may be employed.

In one embodiment, browser 245 may be configured to enable access to a community search application, such as might be available through CSS 106 of FIG. 1. In one embodiment, a user of client device 200 may input to the search application a variety of search terms for use in obtaining a search results. In one embodiment, the user may have selected to enable community searches, such that included with a result of a search is a list of other users that performed a same or similar search query. In one embodiment, the list is filtered based on one or more user preferences, including, but not limited to demographics, time, location, and/or other like. Moreover, the list may be configured such that it further identifies those other users that are currently online and/or otherwise available for a chat session by the user of client device 200. Thus, in one embodiment, the user may select one of the identified users, and based on any implemented security constraints, policies, or the like, initiate a chat session with the selected other user. Then, at least based in part on the chat session, the user of client device 200 (and/or the other user) may then refine their search queries. In one embodiment, the displayed list of other users is integrated with messenger 243 such that a status of the listed users is obtained from messenger 243, and/or a communication is initiated and/or maintained using messenger 243. However, the invention is not so limited and other mechanisms for managing the chat list, and/or chat sessions may also be employed. Moreover, while a chat session is described, the invention may also be configured to enable communications using other mechanisms, including, but not limited to SMS, email, VOIP, or the like.

Messenger 243 may be configured to initiate and manage a messaging session using any of a variety of messaging communications including, but not limited to email, Short Message Service (SMS), Instant Message (IM), Multimedia Message Service (MMS), internet relay chat (IRC), mIRC, RSS feeds, and/or the like. For example, in one embodiment, messenger 243 may be configured as an IM application, such as AOL Instant Messenger, Yahoo! Messenger, NET Messenger Server, ICQ, or the like. In one embodiment messenger 243 may be configured to include a mail user agent (MUA) such as Elm, Pine, MH, Outlook, Eudora, Mac Mail, Mozilla Thunderbird, or the like. In another embodiment, messenger 243 may be a client application that is configured to integrate and employ a variety of messaging protocols, including, but not limited to various push and/or pull mechanisms for client device 200. As described above, messenger 243 may integrate with browser 245 to enable chat search queries.

### Illustrative Network Device

FIG. 3 shows one embodiment of a network device 300, according to one embodiment of the invention. Network device 300 may include many more or less components than those shown. The components shown, however, are sufficient to disclose an illustrative embodiment for practicing the invention. Network device 300 may represent, for example, CSS 106 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

As shown, data stores 352 may include a database, text, spreadsheet, folder, file, or the like, that may be configured to maintain and store subject matter specificity classifier data, threshold values, training documents, document feature sets, search parameter selections for a given searcher, one or more lists of sites over which a search is to be performed, search results, or the like. In one embodiment, at least some of data store 352 might also be stored on another component of network device 300, including, but not limited to cd-rom/dvd-rom 326, hard disk drive 328, or the like.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, SMS message servers, IM message servers, email servers, account managers, and so forth. Web server 357, messaging server 356, search tools 355, and Community Search Manager (CSM) 354 may also be included as application programs within applications 350.

Web server 357 represent any of a variety of services that are configured to provide content, including messages, over a network to another computing device. Thus, web server 357 includes for example, a web server, a File Transfer Protocol (FTP) server, a database server, a content server, or the like. Web server 357 may provide the content including messages over the network using any of a variety of formats, including, but not limited to WAP, HDML, WML, SMGL, HTML, XML, cHTML, xHTML, or the like. Thus, in one embodiment, web server 357 may be configured to enable search queries, provide search results, and to enable a display of a list of other users for use in initiating a chat session, and/or other form of communications.

Messaging server 356 may include virtually any computing component or components configured and arranged to forward messages from message user agents, and/or other message servers, or to deliver messages to a local message store, such as data store 354, or the like. Thus, messaging server 356 may include a message transfer manager to communicate a message employing any of a variety of email protocols, including, but not limited, to Simple Mail Transfer Protocol (SMTP), Post Office Protocol (POP), Internet Message Access Protocol (IMAP), NNTP, or the like. Messaging server 356 may also be managed by one or more components of messaging server 356. Thus, messaging server 356 may also be configured to manage SMS messages, IM, MMS, IRC, RSS feeds, mIRC, or any of a variety of other message types. In one embodiment, messaging server 356 may enable users to initiate and/or otherwise conduct chat sessions, VOIP sessions, or the like, based at least in part on a search query. Thus, in one embodiment, messaging server 356 may be configured to interact with web server 357 for use in managing community searches.

Search tools 355 includes virtually any applications, scripts, robots, spiders, and/or other components useable to perform a search for documents and/or other content based on a search query. Thus, search tools 355 may receive a request to perform a search from one of client devices 101-104 of FIG. 1. Search tools 355 may further receive either in conjunction with the request for the search, and/or prior to the search request, various information indicating over what content to perform the search. For example, search tools 355 might be configured to perform searches over data within a data store, such as data store 352, over content available at a content server, such as content services 107-108 of FIG. 1, or the like. Search tools 355 may then, in one embodiment, provide results of the search to CSM 354.

CSM 354 may be configured to interact with web server 357, messaging server 356, and/or search tools 355 to manage community searches that provide search results with a capability to selectively perform chat sessions with others that have performed a same or similar search query. Thus, a user of network device 300 might employ web server 357 to interact with CSM 354 to register for use of community searches with chat. Registration might include, but is not limited to providing an alias, contact information, constraints on being contacted, or the like. Registration may further include providing to CSM 354 a variety of options. For example, a user of community searches might request that a list of others performing a same or similar search query be filtered based on demographics, location, time, or the like. Thus, for example, a user might select that the list of others be filtered to those that have conducted a same or similar search within some recent time period, are within a particular geographic location, or the like. In one embodiment, CSM 354 might enable a user to select to be notified of those other users that may perform a same or similar search query some time period after the user has performed their search. Thus, a user may receive information about users that performed a same or similar search before them, about a same time as them, and/or some time after they performed their search query. In this manner, users may continue to be informed about similar activities, and thereby obtain the benefit of such actions by others in a community. As used herein, a community may be defined as any user performing a search query and has registered to participate in community search queries with chat capability.

In any event, CSM 354 may receive a search result from search tools 355 based on a user's search query. CSM 354 may then interact with messaging server 356 to identify a community of users that may have performed a same or similar search as based on the user's search query. Any of a variety of mechanisms may be used to determine whether a search is same or similar. For example, keywords within a search might be used, a weighting of the keywords might be used. In another embodiment, keywords from the user's search query might be used to search a data store that is configured based on similar keywords. Thus, while the user might have entered certain keywords, the evaluation might identify words that are considered to be similar, and/or may be useable to generate similar search results. Thus, similar keywords may be grouped together, and use of one of the keywords within a group results in searching for any other user that used any of the keywords within the same group of keywords in their search queries.

After CSM 354 has identified a list of one or more other users having performed a same or similar search query, CSM 354 may further filter the results based on a user's selection options, such as location, demographics, time, or the like. A resulting list may then be presented for display to the search user through web server 357. Should the user then select to communicate with one or more of the identified other users in the list, CSM 354 may monitor and/or manage the requests to ensure privacy, and/or other security policies are maintained. In one embodiment, CSM 354 may provide approved requests for communications to messaging server 356 to enable the user to communicate with the selected other user, refine their searches based on the communications, and/or otherwise enhance their social networks. CSM 354 may employ a process such as described below in conjunction with FIG. 4 to perform at least some of its actions. Moreover, CSM 354 may enable a display of search results integrated with chat capability through web server 357, such as that which is described below in conjunction with FIG. 5.

### Generalized Operation

The operation of certain aspects of the invention will now be described with respect to FIGS. 4. FIG. 4 illustrates a logical flow diagram generally showing one embodiment of an overview process for refining search queries to integrate a search result with chat capability. Process 400 of FIG. 4 may be implemented within CSS 106 of FIG. 1, for example. Process 400 begins, after a start block, at decision block 402, where a determination is made whether a search user has selected to modify their community search options. In one embodiment, such modifications include, but are not limited to registering to participate in community searches with chat functionality, and/or modifying an existing account's user preferences. In one embodiment, the search user might employ their web browser, or other user interface to select a display that enables the user to register and/or modify their user preferences. Selection of such display and/or other selection by the user may be used to determine that the search user is to modify their user search options. If so indicated, processing flows to block 404; otherwise, processing flows to block 406.

At block 404, the user may register, and/or modify their user search options. As such the user might turn on or off display of chat functionality with searches. The user may also turn on/off participation in such chat functionality, such that any of their own search activities are not useable for display to other users. Similarly, a user may establish a variety of filtering criteria useable to filter a list of other users having performed a same or similar search. Thus the user might want to filter the list of other users based on location, for example, seeing those other users within a specific geographic region, or the like. Similarly, the search user may select to filter the list based on time, demographics, and/or any of a variety of other criteria. Moreover, the search user might select to turn on/off notification, whereby the search user is notified of other users that have performed a same or similar search some time after the search user. Having provided the search user's options, processing flows next to block 406.

At block 406, a search query is received from a user's client device. The search query may include one or more search terms. Processing continues to block 408, where based on the search terms in the search query, a list of others is identified that performed a search query using a same or similar search terms. Again, a similar search query may arise where terms that may not be exactly the same as those the current search user has entered were entered by others, but such terms are considered to be similar. For example, consider the current searcher enters “boating in Seattle.” The keyword boating may be identified within the search query, and found to be similar to other keywords in a grouping of keywords related to, for example, boats, sailboats, ships, motorboats, or the like. Clearly, this example is not intended to be exhaustive—nor should it be considered to be limiting. It is merely provided as an illustration of similar term grouping that may arise. Similarly, another non-exhaustive, non-limiting example might include similar terms for Seattle to include, but not be limited to: northwest, Washington State, or the like.

In any event, those other searchers may be identified based on performing a same or similar search query as the current user. The list may then be filtered based on any of a variety of user preferences. For example, in one embodiment, the current searcher may have selected to have the list of other searchers filtered based on location. For example, the current search user might have the list filtered to provide those recent other searchers that reside within a particular geographic region—such as, for example, within about a 50 mile radius of the current searcher, within a same country as the current searcher, same city as the current searcher, or based on any of a variety of other geographic criteria. Similarly, the current searcher might select to have the list filtered based on how recent the other searcher performed the search, whether the other searcher is currently online, or the like, or any of a variety of other filtering criteria.

Processing then flows to block 410, where the filtered list of other searchers may be provided to the current searcher along with results of the current searcher's search query. In one embodiment, the list of other searchers in arranged such that it provides additional information about the other searchers, including, but not limited to an alias, a current online status (such as idle, typing, away from desk, or the like), or other information useable to indicate whether the other searcher may be available for a chat session—or other messaging session. One non-limiting, non-exhaustive screen shot illustrating search results along with a list of identified other searchers having performed a same or similar search query is described in more detail below in conjunction with FIG. 5. It is noted, that because users may go online or offline at virtually any time, in one embodiment, the list of identified other searchers may also be revised, dynamically. Thus, in one embodiment, other searchers that were online, but have gone offline, might be removed from the list. Similarly, those other searchers that were offline but not online, with respect to being available for engaging in chat (or other messaging sessions) may be added to the list. As used herein, the term “online” refers to whether a user has configured their client device in a manner to indicate that their messaging application is active.

Processing next flows to decision block 412, where a determination is made, whether the current search user has selected to initiate a chat session (or other messaging session). Such selection might be performed by the current search user via clicking on an icon, alias, widget, or other symbol, text, link, or the like, useable to select another searcher for chatting. If the current search user has selected to initiate a chat session, processing flows to block 414; otherwise, processing flows to decision block 416.

At block 414, the current user might be allowed to communicate with the selected other searcher via any of a variety of messaging protocols, including, but not limited to those described above. In one embodiment, when the current search user initiates the session, a message might be sent to the selected other searcher indicating that a request to chat is being sent. The other searcher may then select to accept the request, or deny the request. If the other searcher accepts, the messaging session may then proceed. In one embodiment, the current search user might initiate multiple sessions, join other searchers, or perform a variety of other multiple chat communications. In this manner, the current search user, and/or other searchers may be able to discuss their searches, and potentially improve their search queries, and/or enhance their social networks. For example, where a searcher is searching about a death of a well known personality, a disaster, or other tragedy, not only is it anticipated that integrated chats with searches will enable others to improve their searches, but it may also provide a forum for people to share encouragement, grief, or the like. In any event, processing continues next to decision block 416, where a determination is made whether the current search user selects to revise their search query. If so, processing loops back to block 406; otherwise, processing continues to decision block 418.

At decision block 418, a determination is made whether a notification is received about another searcher that has performed a same or similar search query as the current user. Such notification may be optional. For example, where the current search user has performed a search, perhaps even moved on to performing another search, or refining a search, the current search user might receive a notification that another searcher is currently or has just entered a same or similar search. In this manner, the current search user may learn about others that performed same or similar searches before them, about the same time as that of the current search user, and/or after the current search user's search. The notification may be provided using any of a variety of mechanisms, including, but not limited to an alert within a browser window, an email message, an SMS message, IM message, or the like. If a notification is received, processing flows back to decision block 412, where the current search user may select to initiate a chat (or other messaging session) with the newly identified searcher. Otherwise, processing flows to decision block 420, where a determination is made whether the current search user has selected to terminate the community search with chat capability. If the current search user has selected to continue searching, processing loops to decision block 402; otherwise, process 400 returns to a calling process to perform other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

### Non-Limiting Illustrative Screen Display

FIG. 5 illustrates one non-limiting, non-exhaustive embodiment of an example screen shot useable to provide chat functionality integrated with searching. Screen shot 500 may include many more or less components than those shown. The components shown, however, are sufficient to disclose an illustrative embodiment for practicing the invention.

As shown, however, screen shot 500 includes a search query 501 comprising one or more search terms, search results 502, list of online other searchers 504, and notification alert 506.

Search query 501 represents a non-limiting, non-exhaustive example of a current search user's search query. It is recognized that any of a variety of other terms may be entered into a search query field. Thus, the invention is not to be constrained based on this example. Similarly, search results 502 represents one of a plurality of possible results that may be returned based on search query 501.

Other searchers 504 represents those other searchers that are determined to be currently online and therefore potentially available for a chat (or other messaging) session. As may be seen, other searchers 504 may provide an alias, along with an online status (e.g., away, idle, in a session, or the like). In one embodiment, the other searchers 504 may be filtered based on any of a variety of criteria, including but not limited to demographics, location, time, or the like. Moreover, it should be recognized that as another searcher changes their online/offline status, the other searcher may appear or disappear from the list of identified other searchers 504 that have performed a same or similar search query. It should be noted that while search results 502 and other searchers 504 are illustrated as side by side within screen shot 500, the invention is not so limited. For example, other searchers 504 may be displayed above, below, or even on the other side of search results 502, without departing from the scope of the invention.

Screen shot 500 also illustrated one embodiment, of a notification alert 506 that be used to indicate that another user has performed a same or similar search as the current searcher (associated with screen shot 500), but at some time after the current searcher. Notification alert 506 may also be provided to the current searcher using mail, SMS, IM, or any of a variety of other mechanisms. For example, in one embodiment, should the current search user sign off of their search query, they might still be notified of other searches being performed. In this manner, the current searcher may be informed about same or similar searches, even when the current search user is no longer performing a search. Thus, in one embodiment, options may be selected that enable the current search user to be notified about any of their prior searches, and/or one or more particular searches.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A network device, comprising:
a transceiver to send and receive data over a network; and
a processor that is operative to perform actions, including:
receiving from a client device a search query;
performing an analysis of the search query to determine similar search queries;
identifying one or more other searchers having performed a same or similar search query to the received search query;
selectively providing to the client device information about the one or more other searchers with a result of the search query; and
enabling the client device to initiate a messaging session with the one or more other searchers having performed the same or similar search query.

2. The network device of claim 1, wherein selectively providing information further comprises filtering the identified one or more other searchers based on at least one of a demographics, a location, or a time.

3. The network device of claim 1, wherein the processor is operative to perform actions, further including:
monitoring for another searcher having performed a same or similar search query at some defined time subsequent to the received search query from the client device; and
if another searcher is detected, providing a notification to the client device indicating that another searcher has subsequently performed the same or similar search query.

4. The network device of claim 1, wherein identifying one or more other searchers further comprises identifying one or more other searchers that are detected as currently being online with a messaging application.

5. The network device of claim 1, wherein identifying one or more other searchers further comprises modifying a list of identified one or more other searchers to add searchers that are detected to be online with a messaging application for participating in a chat session, or removing from the list searchers that are detected to have gone offline.

6. The network device of claim 1, wherein the messaging session comprises at least one of a chat session, a VOIP session, or an SMS session.

7. A system that is operative to manage a search query, comprising:
a messaging service configured to enable users to communicate using at least a chat session; and
a network device that is configured to perform actions, including:
receiving from a client device a search query;
performing an analysis of the search query to determine similar search queries;
identifying a list of one or more other searchers having performed a same or similar search query to the received search query;
selectively displaying to the client device information about the one or more other searchers with a result of the search query; and
enabling the client device to initiate a chat session using the messaging service with the one or more other searchers having performed the same or similar search query.

8. The system of claim 7, wherein determining similar search queries further comprises identifying search terms that are determined to be related to one or more search terms in the search query.

9. The system of claim 7, wherein selectively providing information further comprises dynamically revising the provided information based on an online status of each of the one or more other searchers.

10. The system of claim 7, wherein the network device that is configured to perform actions, further including:
detecting another search query from a second client device, wherein the other search query is same or similar to the search query from the client device, and performed subsequent to the received search query; and
providing a notification to the client device, indicating that a second client device has performed the same or similar search query.

11. The system of claim 7, wherein selectively providing information further comprises filtering the identified one or more other searchers based on at least one of a demographics, a location, or a time.

12. A computer-readable storage medium having computer-executable instructions, the computer-executable instructions when installed onto a computing device enable the computing device to perform actions, comprising:
receiving from a client device a search query;
identifying a list of one or more other searchers having performed a same or similar search query to the received search query;
selectively displaying at the client device information about the one or more other searchers with a result of the search query, wherein the one or more other searchers are further identified as being online with respect to a chat application; and
enabling the client device to initiate a chat session with the one or more other searchers having performed the same or similar search query.

13. The computer-readable storage medium of claim 12, wherein selectively displaying at the client device information about the one or more other searchers with a result of the search query further comprises, removing at least one other searcher from the display if the one other searcher is detected as going offline with respect to the chat application.

14. The computer-readable storage medium of claim 12, wherein selectively providing information further comprises filtering the identified one or more other searchers based on at least one of a demographics, a location, or a time.

15. The computer-readable storage medium of claim 12, wherein enabling the client device to initiate a chat session, further comprises providing a request for at least one other searcher to accept a chat session with the client device.

16. The computer-readable storage medium of claim 12, wherein a similar search query is determined based on a comparison of search terms.

17. A method of performing a search query, comprising:
receiving from a first client device a search query;
identifying a list of one or more other searchers having performed a same or similar search query to the received search query;
selectively displaying at the first client device information about the one or more other searchers with a result of the search query, wherein the one or more other searchers are further identified as being online with respect to a messaging application; and
enabling the client device to initiate a messaging session with the one or more other searchers having performed the same or similar search query.

18. The method of claim 17, wherein selectively providing information further comprises filtering the identified one or more other searchers based on at least one of a demographics, a location, or a time.

19. The method of claim 17, further comprising:
if a second client device is detected as providing the same or similar search query subsequent to the first client device, providing a notification to the first client device about the second client device.

20. The method of claim 17, further comprising:
receiving at least one user preference from the first client device that is configured to filter the identified list of one or more other searchers.
